(19) United States
(12) Patent Application Publication
(10) Pub. No.: US 2019/0022900 A1
(43) Pub. Date: Jan. 24, 2019

(54) METHOD FOR MAKING OXYGEN REMEDIATING MELT-INCORPORATED ADDITIVES IN PLASTICS FOR PACKAGES

(71) Applicants: George D. SADLER, (US); PERFORMANCE MANAGING AND CONSULTING, INC., Las Vegas, NV (US)

(72) Inventor: George D. SADLER, Elgin, IL (US)

(21) Appl. No.: 16/035,029

(22) Filed: Jul. 13, 2018

Related U.S. Application Data
(60) Provisional application No. 62/536,248, filed on Jul. 24, 2017.

(51) Int. Cl. B29C 37/00; B29C 47/00; B29C 47/08

(52) U.S. Cl. CPC B29C 37/0032; B29K 2105/0023; B29C 47/0896; B29C 47/0009

(57) ABSTRACT

A product and method for providing oxygen remediating extruded or other melt-phase plastics for packages for reducing oxygen-linked damage to foods, pharmaceuticals, or other oxygen sensitive substances. The method for making oxygen remediating melt-phase incorporated plastics for packages and packaging elements generally includes the addition of an oxygen managing combination of compounds that restrict the migration of oxygen and/or eliminate migration oxygen through reaction with components of the polymer additive. Dry components remain inactive until moisture from the packaged food partially deliquesces a formulary component to trigger oxidation of a powdered metal or other oxidizing compound. Other additives absorb and distribute moisture and facilitate electron movement for improved oxidation.

### CROSS REFERENCE TO RELATED APPLICATIONS

This application claims the benefit of priority under 35 U.S.C. § 119(e) to U.S. Provisional Patent Application No. 62/536,248, filed Jul. 24, 2017. The disclosure set forth in the referenced application is incorporated herein by reference in its entirety.

### FIELD OF THE DISCLOSURE

The present disclosure relates generally to oxygen controlling plastic packaging, and more specifically it relates to a method for making oxygen remediating melt-incorporated additives for plastics for packages which reduce oxygen-linked damage to foods, pharmaceuticals, or other oxygen sensitive matter.

### BRIEF SUMMARY OF THE DISCLOSURE

The disclosure generally relates to oxygen suppressing and/or oxygen removing plastic packaging. The packaging includes an oxygen-managing additive (hereinafter alternatively referred to as the “additive” or the “polymer additive”) made from a combination of compounds that restrict the migration of oxygen and/or remove migrating oxygen through chemical reaction. Dry components remain inactive until moisture from the packaged food is fully or partially absorbed by an additive component that triggers oxidation of a powdered metal or other oxidizing compound. Other optional additives absorb and distribute moisture and/or facilitate electron movement to promote oxidation. One or more additives may additionally be formulated based on the equilibrium relative humidity (ERH) of the food contained within the enclosed volume of the additive-modified polymer.

The compositions of the present disclosure can be described as embodiments in any of the following enumerated clauses. It will be understood that any of the embodiments described herein can be used in connection with any other embodiments described herein to the extent that the embodiments do not contradict one another.

1. A plastic packaging material comprising a polymer and an oxygen reactive compound dispersed within the polymer, wherein the polymer comprises tortuous paths therein capable of restricting migration of oxygen through the plastic packaging material.

2. The plastic packaging material of clause 1, wherein the oxygen reactive compound is capable of chemically reacting with oxygen that migrates into the plastic packaging material.

3. The plastic packaging material of clause 1 or 2, further comprising a hygroscopic compound dispersed within the polymer.

4. The plastic packaging material of clause 3, wherein the hygroscopic compound induces the tortuous paths in the polymer.

5. The plastic packaging material of clause 3 or 4, wherein the oxygen reactive compound remains inactive until moisture fully or partially deliquesces the hygroscopic compound.

6. The plastic packaging material of any of clauses 3-5, further comprising at least one hydrophilic compound dispersed within the polymer, wherein the hydrophilic compound is capable distributing products of water and the hygroscopic compound.

7. The plastic packaging material of any of the preceding clauses, wherein the polymer is a polyolefin or ethylene-vinyl acetate.

8. The plastic packaging material of any of the preceding clauses, wherein the oxygen reactive compound comprises a metal selected from the group consisting of iron, aluminum, chrome, zinc, tin, combinations thereof, and alloys thereof.

9. The plastic packaging material of any of clauses 3-6, wherein the hygroscopic compound is selected from the group consisting of potassium sulfate, potassium nitrate, potassium chloride, sodium chloride, magnesium nitrate, potassium carbonate, magnesium chloride, and potassium acetate.

10. The plastic packaging material of clause 6, wherein the hydrophilic compound is selected from the group consisting of an acid, a base, an ionic compound, activated carbon, carbon black, and a mineral.

11. The plastic packaging material of clause 6 or 10, wherein the hydrophilic compound is selected from the group consisting of cellulose, a modified cellulose, polyethylene glycol, polyacrylic acid, polymethacrylic acid, polyvinyl alcohol, polyvinyl acetate, chitosan, a protein, a dextrin, a starch, polyquaternium, polyacrylamide, another cationic polymer, and another anionic polymer.

12. The plastic packaging material of any of the preceding clauses, further comprising an organic compound selected from the group consisting of ascorbic acid, cysteine, a bisulfite, a thiosulfate, and combinations thereof.

13. The plastic packaging material of any of clauses 3-6 or 10-11, wherein the oxygen reactive compound and the hygroscopic compound are uniformly distributed in the polymer.

14. A packaged food product comprising a) food and b) a plastic packaging material enclosing the food, the plastic packaging material comprising a polymer, an oxygen reactive compound dispersed within the polymer, and a hygroscopic compound dispersed within the polymer, wherein the polymer comprises tortuous paths therein capable of restricting migration of oxygen through the plastic packaging material.

15. The packaged food product of clause 14, wherein the oxygen reactive compound remains inactive until moisture fully or partially deliquesces the hygroscopic compound at a triggering relative humidity of the hygroscopic compound.

16. The packaged food product of clause 15, wherein the triggering relative humidity of the hygroscopic compound is less than the equilibrium relative humidity (ERH) of the food.

17. The packaged food product of clause 15 or 16, wherein the triggering relative humidity of the hygroscopic compound is greater than the ERH of ambient environment outside of and surrounding the plastic packaging material.

18. The packaged food product of any one of clauses 15-17, wherein the triggering relative humidity of the hygroscopic compound is within 10% of the ERH of the food.

19. A method for forming plastic packaging for food, the method comprising a) mixing an oxygen reactive compound and a hygroscopic compound into a polymer to form the plastic packaging, wherein the hygroscopic compound creates tortuous paths in the polymer and the tortuous paths are capable of restricting migration of oxygen through the plastic packaging and b) enclosing the food in the plastic packaging.

20. The method of clause 19, further comprising selecting the hygroscopic compound based on the ERH of the food such that the resulting humidity surrounding the food after the packaging step reduces damage to the food.

The disclosure sets forth certain illustrative embodiments that should not be construed to limit the invention as claimed.

### BRIEF DESCRIPTION OF THE DRAWINGS

FIG. 1 is a schematic side view showing a portion of a plastic packaging having an oxygen limiting combination of compounds that restricts the migration of oxygen and/or eliminates migrating oxygen.

FIG. 2 shows oxygen air saturation over time inside an injection-molded sipper structure containing 10% additive that has been moisture-triggered, showing oxygen removal exceeding oxygen permeation after approximately 2 days.

FIG. 3 shows oxygen permeation through a sipper made from an untriggered additive-containing sample with the steady-state permeation region coinciding with the linear regression line. Permeation is calculated from b[1], the slope of the regression line (having units of % oxygen increase per hour). The value b[0] in FIG. 3 represents the y-intercept and r2 represents the correlation coefficient.

FIG. 4 shows oxygen permeation through a sipper made from virgin HDPE (no additive) with the stead-state permeation region coinciding with the linear regression line. Permeation is calculated from b[1], the slope of the regression line (having units % oxygen increase per hour). The value b[0] in FIG. 4 represents the y-intercept and r2 represents the correlation coefficient.

FIG. 5 is a graph of air saturation over time for virgin, untriggered, and triggered samples.

### DETAILED DESCRIPTION OF ILLUSTRATIVE EMBODIMENTS

### A. Overview

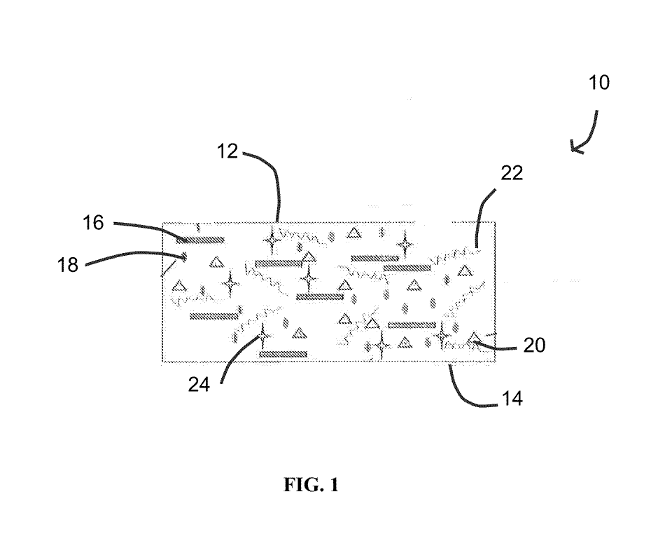

FIG. 1 illustrates the addition of an oxygen limiting combination of compounds that restrict the migration of oxygen and/or eliminate migrating oxygen through reaction with one or more component(s) of the polymer additive. Dry reactive components remain inactive until moisture from the packaged food (or other moisture containing packaged substance) is sufficiently absorbed by components of the polymer additive to form one or more hydrated compounds. Dry components may fully or partially deliquesce. The one or more hydrated compounds then trigger oxidation of a powdered metal or other oxidizing additive ingredient. Optional additives may be included and may absorb and distribute moisture and facilitate electron movement to promote increased oxidation.

Still referring to FIG. 1, a polymer 10 has a top edge 12 representing the packaging surface in contact with the atmosphere and the lower edge 14 representing the food contact side of the polymer. The term “food-contact side” is illustrative only, and embodiments described herein are not limited to food, but may include pharmaceuticals or any other oxygen-sensitive material. Various possible components to an oxygen suppressing and/or oxygen scavenging system are included.

As shown in FIG. 1, the additive melt-mixed with the polymer contains tortuosity-inducing components 16. Oxygen cannot penetrate through paths created by these components in any significant concentration. Instead, oxygen migrates around diffusional barriers created by the tortuosity-inducing components 16. The imposed circuitous path slows oxygen migration through the polymer thereby restricting the total oxygen load entering the food-contact surface.

The polymer additive may also contain one or more oxygen reacting compounds 18, such as an oxidizable metal. As used herein, an “oxygen reacting compound” or an “oxygen reactive compound” is a compound capable of reacting with oxygen in accordance with the present disclosure. Unlike tortuosity-inducing compounds, which introduce a physical barrier to oxygen migration, oxygen-reactive compounds 18 remove oxygen through one or more chemical reactions. However, in some embodiments, oxygen-reactive compounds 18 may also induce tortuosity.

The polymer additive may also contain one or more hygroscopic compounds 20, usually a salt which, upon absorbing water, creates a hydrated phase rich in disassociated ions and triggers oxidation of the oxygen reacting compound 18. In some embodiments, the one or more hygroscopic compounds 20 are one or more deliquescent compounds.

In some embodiments, the additive may additionally contain some hydrophilic compound 22 capable of absorbing and distributing the liquid products of water and hygroscopic compound 20.

In some embodiments additional activating compounds 24 may be added. These include (but are not limited to) compounds with acid, base, or buffering capability.

### B. Oxygen Remediating Modification of Polymers Via Addition of Tortuosity-Inducing Substances and Oxygen-Reacting Agents

Prior to extrusion, the additive containing a combination of substances is melt-mixed into a polymer. By introducing the additive to the polymer, the polymer is physically modified to impede oxygen's access to food (or other oxygen sensitive components) through introduction of physical barriers to oxygen migration and/or through removal of migrating oxygen via chemical reaction. Preferably, chemical removal of oxygen remains substantially inactive until food (or another moisture-containing component) fills the package made from the polymer.

Migration of moisture from food into the polymer promotes incipient moisture absorption and/or deliquescence of the salt. The resulting disassociation of the hydrated salt into positive and negative ions promotes oxidation of the oxygen-reactive metal.

Minerals such as (but not limited to) talc, mica, kaolin clay, celite, vermiculite, zeolites, titanium dioxide, or combinations of the foregoing may be added to a polymer to impose a physical barrier to oxygen migration from the atmosphere to the inner oxidizable component of the package. The selected minerals are themselves impervious to oxygen migration. Any oxygen entering the package from the external environment migrates in a circuitous path around the mineral inclusions. In an embodiment, the aspect ratio of the minerals may be such that their width may be 10 or more times greater than their thickness. Such minerals are said to have a high aspect ratio. This high aspect ratio favors a stacking alignment of mineral platelets to increase the tortuosity of the oxygen migration path from the atmosphere to the inner package structure containing the packaged oxygen sensitive material, thereby reducing the likelihood that oxygen can enter the package. Additionally, the minerals contain some ionic binding affinity for the salt or other compound that serves as the hygroscopic triggering agent for the oxygen-removing activity. Aluminosilicate compounds such as kaolin clay, mica and zeolite have Lewis acid functionality which facilitates oxidation of the metal and may be included. Therefore such minerals potentially play a fourfold role in the additive by providing tortuosity, by surface binding/distributing triggering components, by providing a path for surface distribution of triggering moisture, and by enhancing the oxidation of the metal through acid-catalyzed processes. Titanium dioxide also contains Lewis acid functionality. Therefore it can serve the dual role of facilitating oxidation as well as providing whiteness to offset the color contribution of other additive components.

Oxygen is detrimental to many foods. While some polymers and laminates provide excellent barrier to oxygen migration, these tend to be expensive and/or are impractical to extrude. They may also often present problems in attachment to other packaging components. The low-cost packaging applications described herein predominantly use polyolefins, although other polymers may be employed. In some embodiments, the present disclosure illustrates coupling of two methods of oxygen remediation, although it is contemplated that either embodiment may be employed on its own. The first introduces compounds, usually minerals which are refractory to oxygen migration. In some embodiments, such compounds have a high aspect ratio. Aspect ratio is the ratio of surface width to thickness. A high aspect ratio allows tight stacking of the mineral with comparatively little polymer in the interstitial region to induce plaque-to-plaque adhesion. Because the mineral is impermeable to oxygen migration, any oxygen entering the system winds through the tortured polymer path between the mineral plaques. The higher the aspect ratio, the more tortuous the migration path. This added tortuosity increases the length oxygen travels in its trek from the external atmosphere to the oxygen-sensitive contents. The amount of migration is inversely proportional to the distance of the migrating path. Therefore, less oxygen migrates through the package when that package contains more tortured paths for migration. The tortuosity-inducing plaques reduce the amount of polymer in the piece and tend to cluster active components between the corridors through which oxygen and moisture, which activate such active components, travel. Additionally, tortuosity inducing minerals often have high ionic binding potential. Ion binding can facilitate dispersal of hygroscopic triggering compounds and thereby accelerate the rate of oxygen removal.

The second approach to remediating oxygen is to remove oxygen through reaction. Most metals react with oxygen to some extent. There are also many food grade organic compounds, such as unsaturated fats and ascorbic acid, that react with oxygen. The potential for high density of metals favors their use as oxygen-removing agents. The density of metals typically exceeds the density of organic compounds several fold. Therefore per unit weight, the volume of metals is comparatively small. This offers the advantage that the bulk properties of the polymer are not overwhelmed by a relatively small amount of additive. As with tortuosity-inducing minerals, oxygen cannot enter intact metals. Therefore, oxygen removal occurs at the metal surface. Additionally, the high surface area of finely powdered metals favors oxygen removal. As such, the metal will preferably be finely powdered metal for increased efficiency. High mesh iron and certain other metals come in atomized, electrolytic, and porous (sometimes called spongy, mossy, or hydrogen reduced) variants. All of these variants may suitably remove oxygen. In some applications, nonporous iron is used. Nonporous iron may have a smaller particle size and be easier to extrude compared to porous iron. In other applications, a porous iron is used. The porous particles themselves may impart tortuosity. Also much of the oxygen reactivity occurs within interior pores. Therefore porous structures have a high reactivity-to-surface area ratio. Only the surface of the metal particle imparts color to the additive-containing polymer. Therefore porous metals may minimize any metal-related color impact to the additive-containing polymer.

In addition to minerals, in some embodiments tortuosity may be introduced using barrier polymer flakes or other organic materials known to have no or limited ability to permeate oxygen. For example pure crystals of polymers or other organic compounds will not permeate oxygen and therefore may be used to add tortuosity. In some embodiments, inexpensive bulking agents such as plant-derived fiber may provide migration barrier for oxygen. In further embodiments, barrier polymers such as EVOH (ethylene co-vinyl alcohol) may be added to impose migration barriers. Additionally glasses, ceramics, and metal flakes may be added to induce tortuosity.

Several types of metal are suitable for general or limited food contact use. These include iron, aluminum, chrome, zinc, tin, and combinations and/or alloys of the foregoing. Each of these metals has some tendency toward oxidation. Iron and tin react readily with molecular oxygen to provide rapid removal of oxygen. Zinc oxidizes to a matte patina which resists further oxidation. Chrome and aluminum both oxidize almost instantaneously to form a transparent coating that resists further reaction with oxygen, making them unsuitable candidates alone. However, alloys of two or more metals, even if those metals are unacceptable in themselves, may sometimes be used to remove oxygen. For example alloys of aluminum and zinc react quickly with oxygen and may be practical for incorporation into packaging materials for oxygen removal. Some organic compounds such as ascorbic acid, cysteine, bisulfites, and thiosulfates remove oxygen and are approved for direct addition into foods. Such materials might be used alone or in combination with powdered metals.

### C. Deliquescent Triggering Agent

At least one substance of the combination of substances added to modify the polymer may be a substance which absorbs water and/or begins to deliquesce at a characteristic equilibrium relative humidity (ERH), also referred to herein as a “triggering relative humidity” or “triggering ERH.” Below this triggering relative humidity, reactive components remain dry and little or no oxygen removal occurs. Above the triggering relative humidity, the deliquescent additive partially or fully liquefies to trigger the process of oxygen removal. This material-specific ERH is similar in some respects to dew point for cooled surfaces. For example, a substance may begin to absorb water at a sharp and predictable moisture level. The preferable triggering ERH is less than the ERH of the food but greater than the ERH of the ambient environment. For many fluid foods the triggering ERH may be between about 92% and about 100% relative humidity. For dry foods the ERH may be as low at about 17%. The ERH of the food may dictate the deliquescent material used in the combination of substances added to activate the polymer. It is also desirable (though not essential) for the deliquescent material to be absorbed on the surface of the tortuosity-inducing substance to increase the surface area of the triggering agent and to disperse the triggering agent's activity uniformly throughout the polymer.

The oxidation of metals typically involves some moisture and is accelerated by an immediate environment rich in ions. In most cases, enclosing an oxygen scavenging metal in a polymer would tend to protect the metal against oxidation. Indeed. metals (ferric metals in particular) are often painted, powder coated, or dipped in plastic to prevent oxidation. In some embodiments, the current disclosure incorporates some deliquescent material, often mineral salts, into the polymer to draw moisture out from the food to initiate deliquescence of the salt. Salts (and other hygroscopic compounds) begin to solubilize at some ERH characteristic of the material.

By selecting a compound which deliquesces at an ERH lower than the ERH imparted by the food but greater than the ERH of external environment, liquefaction with subsequent triggering of oxidation can be tailored to activate oxygen removal upon filling the package with a food with an ERH greater than the triggering ERH of the triggering compound. ERH-triggering guards the metal from premature exhaustion since little or no metal oxidation occurs prior to filling the package so long as the ERH of the environment surrounding the empty package is below the triggering ERH of the salt.

A salt can be found which deliquesces in virtually any ERH range. For example the ERH triggering range of several common salts includes potassium sulfate (98% ERH), potassium nitrate (96% ERH), potassium chloride (86% ERH), sodium chloride (76% ERH), magnesium nitrate (53%), potassium carbonate (43% ERH), magnesium chloride (33% ERH), potassium acetate (22% ERH), and lithium chloride (11% ERH). With the exception of lithium chloride, all of these salts have food contact approval. Once deliquescence is triggered, the disassociated salt ions catalyze oxidation of the metal. Many organic compounds also have deliquescence points and may be used either instead of or in conjunction with salts.

D. The Presence of Deliquescent Materials that Control the Equilibrium Relative Humidity

The deliquescent material added to trigger oxygen removal also poises the ERH at the characteristic triggering humidity of the salt. Therefore, careful selection of the deliquescent ERH can both trigger oxygen removal and control the ERH in the free space surrounding the food.

The ERH is stabilized around a material's deliquescence point. By carefully selecting the oxidation-triggering salt, it is often possible to find a single salt, or combination of salts, that, along with oxygen triggering simultaneously controls the ERH in region which is ideally beneficial to a given food. The same materials used for ERH-stabilization are used for deliquescent triggering and typically constitute mineral salts.

As with deliquescent salt triggering of oxygen removal, organic deliquescent materials also exist for control of ERH. These can be used either independently or in combination with deliquescent salts.

### E. The Inclusion of Hydrophilic Polymers to Bind and Distribute Deliquescent Liquid

In some embodiments, a hydrophilic colloid (or other hydrophilic chemical), which acts as a wick (or dispersing agent) to disperse the deliquescent liquid throughout the polymer melt, may be included. Such a material may contain acid, base or ionic functionality to enhance oxidation of the oxygen sensitive component. However the material may be a simpler material such as activated carbon or carbon black or a mineral.

Localized puddling of deliquescent fluid is in some cases possible but may be undesirable. Various hydrophilic polymers can absorb moisture and provide a potential path may be for moisture distribution throughout the activated polymer system. Some of these polymers also have ionic side groups that facilitate oxidation of the powdered metal or other oxidizable component in the additive mix. Certain polymers also conduct electricity. In some embodiments, these may be added to the additive mix to facilitate electron flow and exchange related to the oxidation process.

Some of these polymers have ionic side groups that facilitate oxidation of the powdered metal or other oxidizable components in the additive mix. Certain polymers also conduct electricity. These might be added to the mix to facilitate electron transport and exchange related to the oxidation process.

F. Compounds which Facilitate Oxidation of the Oxygen Reacting Compound

Additional compounds might optionally be added to facilitate the oxidation of the oxygen reacting compound. Such compounds include, but are not limited to: powdered acids, powdered bases, ionic polymers, surfactants, electrically conductive polymers, buffers, and combinations of the foregoing.

### G. Connections of Elements of the Invention

In general, the elements may represent optional or elective formulation components or components that may be desirable for one formulation and not desirable for certain variant formulations.

For example, the tortuosity-inducing compounds may also serve as the deliquescent triggering agent. In some cases the oxygen reactive compound may also serve to induce tortuosity either alone or in combinations with other tortuosity-inducing components. In some cases the deliquescent material will be selected to control ERH and not just oxygen alone. In this case a different salt other than the triggering salt might be selected to serve the joint function of triggering agent and ERH control. It is also possible that some deliquescent materials (those with very low deliquescence points) may fully liquefy within the polymer. In these cases some hydrophilic polymer or other humectant might be employed to absorb and distribute fluid components. Additionally, the pH and ionic environment might be adjusted with acids, bases, or buffers in some embodiments.

### H. Operation of Illustrative Embodiment

A polymer additive system is described which significantly reduces oxygen access to oxygen sensitive foods, pharmaceuticals, or other oxygen sensitive compounds.

A polymer additive system is described which significantly reduces oxygen access to packaged oxygen sensitive foods and/or other oxygen sensitive materials. The additive may be a combination of at least three components. One component is a mineral, preferably having high aspect ratio, which serves as a physical barrier to migration of oxygen. The second component is an oxidizable component, usually a powdered metal, which removes oxygen through chemical reaction. The third component is a triggering agent usually comprising a deliquescent salt.

In some embodiments, the additive formulation comprises about 1 to about 5, about 1 to about 4, about 1 to about 3, about 2 to about 5, or about 3 to about 5 parts by weight of one or more oxygen-reacting compounds or elements. In some embodiments, the additive formulation comprises about 0.1 to about 5, about 0.1 to about 4, about 0.1 to about 3, about 1 to about 5, about 1 to about 4, about 1 to about 3, about 2 to about 5, or about 3 to about 5 parts by weight of one or more hygroscopic compounds. In some embodiments, the additive formulation comprises about 0.1 to about 5, about 0.2 to about 5, about 0.5 to about 5, about 1 to about 5, about 0.1 to about 2, about 0.2 to about 2, about 0.5 to about 2, or about 1 to about 2 parts by weight of one or more tortuosity-inducing compounds. The additive formulation may be introduced to a plastic by first adding about 1 to about 10, about 2 to about 6, or about 4 parts by weight of a carrier liquid.

In some embodiments, the additive formulation comprises about 1 to about 5, about 1 to about 4, about 1 to about 3, about 2 to about 5, or about 3 to about 5 parts by weight electrolytic iron. In some embodiments, the additive formulation comprises about 1 to about 5, about 1 to about 4, about 1 to about 3, about 2 to about 5, or about 3 to about 5 parts by weight sodium chloride. In some embodiments, the additive formulation comprises about 0.1 to about 5, about 0.2 to about 5, about 0.5 to about 5, about 1 to about 5, about 0.1 to about 2, about 0.2 to about 2, about 0.5 to about 2, or about 1 to about 2 parts by weight titanium dioxide. The additive formulation may be introduced to a plastic directly or by first adding thereto about 1 to about 10, about 2 to about 6, or about 4 parts by weight of a mineral oil.

In some embodiments, the additive formulation comprises about 1 to about 5, about 1 to about 4, about 1 to about 3, about 2 to about 5, or about 3 to about 5 parts by weight electrolytic iron. In some embodiments, the additive formulation comprises about 0.1 to about 5, about 0.1 to about 4, about 0.1 to about 3, about 1 to about 5, about 1 to about 4, about 1 to about 3, about 2 to about 5, or about 3 to about 5 parts by weight sodium chloride. In some embodiments, the additive formulation comprises about 0.1 to about 5, about 0.2 to about 5, about 0.5 to about 5, about 1 to about 5, about 0.1 to about 2, about 0.2 to about 2, about 0.5 to about 2, or about 1 to about 2 parts by weight titanium dioxide. In some embodiments, the additive formulation comprises about 0.1 to about 5, about 0.2 to about 5, about 0.5 to about 5, about 1 to about 5, about 0.1 to about 2, about 0.2 to about 2, about 0.5 to about 2, or about 1 to about 2 parts by weight clay. The additive formulation may be introduced to a plastic directly or by first adding thereto about 1 to about 10, about 2 to about 6, or about 5 parts by weight of a mineral oil.

In a preferred embodiment, about 3 parts by weight electrolytic iron, about 3 parts by weight sodium chloride, and about 1 part by weight titanium dioxide comprise the additive formulation. The additive formulation may be introduced to a plastic directly or by first adding thereto about 4 parts by weight mineral oil.

In another preferred embodiment, about 3 parts by weight electrolytic iron, about 1 part by weight sodium chloride, and about 1 part by weight titanium dioxide comprise the additive formulation. The additive formulation may be introduced to a plastic directly or by first adding thereto about 4 parts by weight mineral oil.

In yet another preferred embodiment, about 2 parts by weight electrolytic iron, about 1 part by weight sodium chloride, about 1 part by weight titanium dioxide, and about 1 part by weight clay comprise the additive formulation. The additive formulation may be introduced to a plastic directly or by first adding thereto about 5 parts by weight mineral oil.

In a preferred embodiment, about 2 parts electrolytic iron, about 1 part sodium chloride, about 1 part titanium dioxide, and about 1 part Kaolin (“China” clay) comprise the additive formulation. In some embodiments, all components are less than about 10 microns particle size.

In a preferred embodiment, an already fine NaCl called flour salt is provided and run in a ball mill to further pulverize it. Next the iron powder is added to the mix, and the mix is tumbled to impregnate the salt into the iron particles. Finally the titanium dioxide and clay are added. The mixture is tumbled together in the ball mill to break up the titanium dioxide, which has a tendency to clump.

The additive is uniformly distributed via extrusion mixing or some other form of melt incorporation into a plastic, typically a polyolefin. For example, the polyolefin may be polyethylene, polypropylene, a copolymer thereof, or a combination of the foregoing. In additionally embodiments, the plastic may be ethylene-vinyl acetate (EVA). The additive may be introduced via a liquid vehicle such as mineral oil or another food grade liquid vehicle. Alternatively, the additive may be introduced in dry form. The mixture is injection molded or otherwise thermally formed into packages or packing components such as, but not limited to, fitments, caps, sippers, and dispensing elements. The additive may also be incorporated into a hot melt glue polymer and subsequently melt-metered into caps or other structures. The completed piece is then formed or incorporated via typical commercial processes into/onto a finished container, closure, package or other structure in which the inner contents are kept separate from the external environment as a means of safeguarding the enclosed contents from atmospheric damage such as damage due to oxygen, moisture, and/or microorganisms.

In some embodiments, the additive components may be added to the plastic amounts such that the resulting plastic has up to about 5 wt %, about 10 wt %, about 15 wt %, or about 20 wt % additive. Additionally, the resulting plastic may have about 1 wt % to about 25 wt %, about 5 wt % to about 20 wt %, about 5 wt % to about 15 wt %, or about 7 wt % to about 12 wt % additive. A liquid carrier, such as mineral oil, may be added to these amounts of the additive components for purposes of introduction of these components into the plastic.

The oxygen reactive component of the mix remains fundamentally inactive until a food or other moisture-containing oxygen sensitive component is filled into the container. The deliquescent salt may be carefully chosen to deliquesce at an equilibrium relative humidity (ERH) which is lower than the ERH provided by the food (or other oxygen sensitive contents), but is higher than the ERH of the expected ambient external environment.

Once the package is filled, the salt draws water into the plastic, and the water begins to deliquesce the salt. The ions produced from ionization of the deliquesced salt triggers oxidation of the metal in the presence of oxygen. Therefore oxygen is blocked by the high aspect ratio mineral from entering the contained area and is also removed from the internal food contact chamber due to reaction with the oxidizable component. Premature oxidation of the component is restricted by carefully mating the food and the triggering material. In some cases, such as with “dry” foods where a very low ERH is expected for the food and the external environment is high in humidity, some protection against environmental activation (such as keeping components in a closed bag before use) might be utilized.

The reactive mix may also contain other components to facilitate the reaction rate for oxygen removal. Such components might include hydrophilic polymers (with or without ionic functionality), acids, bases, and buffers.

Deliquescent salts tend to poise the ERH at their characteristic ERH. Therefore, careful selection of the salt can also control the ERH to a value beneficial to the food. ERH control can be used for any moisture sensitive food with or without coupled control of oxygen.

Oxygen Remediating Modification of Polymers Via Addition of Tortuosity-Inducing Substances and Oxygen Reacting Agents

The additive may include tortuosity-inducing minerals (for example as micro-sized powders) such as (but not limited to) talc, mica, kaolin clay, celite, vermiculite, and/or zeolite, which may be added to the polymer provide a physical barrier to oxygen migration from the atmosphere to the inner package containing food. The minerals are selected which present an impervious or substantially impervious barrier to oxygen migration. Oxygen entering from the environment migrates in circuitous path around the mineral inclusions. Preferably the aspect ratio of minerals is such that their width is 10 or more times greater than their thickness. Such minerals are said to have a high aspect ratio. A high aspect ratio favors a stacking alignment of mineral platelets to increase the tortuosity of the migration path for oxygen traversing from the atmosphere to the inner package structure containing the packaged oxygen sensitive material. Additionally, the minerals may contain some level of binding affinity for the salt or other compound that serves as the deliquescent triggering agent for activity.

Minerals preferably have an aspect ratio (width/thickness) greater than 10 and more preferably greater than 100.

Minerals may have some ion binding capability to absorb triggering agent.

Oxygen reacting materials include but are not limited to one or a combination of finely ground (<10μ) elemental iron, tin, zinc.

Deliquescent Triggering Agent

Typically a salt is selected such as (but not limited to) potassium sulfate (98% ERH), potassium nitrate (96% ERH), potassium chloride (86% ERH), sodium chloride (76% ERH) magnesium nitrate (53%, potassium carbonate (43% ERH), magnesium chloride (33% ERH), potassium acetate (22% ERH), or lithium chloride (11% ERH).

The Presence of Deliquescent Materials that Control the Equilibrium Relative Humidity

Salts selected may be those as described above for deliquescence but selected with an eye toward the ideal ERH of the food.

The Inclusion of Hydrophilic Polymers to Bind and Distribute Deliquescent Liquid

Hydrophilic polymers include but are not limited to cellulose, modified celluloses (such as hydroxymethyl cellulose, methyl cellulose, ethyl cellulose etc.) polyethylene glycol, polyacrylic acid, polymethacrylic acid, polyvinyl alcohol, poly vinyl acetate, chitosan, proteins, dextrins, starches (with and without modification) polyquaternium, polyacrylamide and other cationic, anionic polymers.

Compounds which Facilitate Oxidation of the Oxygen Sensitive Component

Compounds which may be added to facilitate oxidation of the oxygen sensitive component include organic acids (and their salts) including (but not limited to) tannins, benzoic, oxalic, citric, malic, tartaric, ascorbic, carbonate, bicarbonate, monocalcium phosphate, sodium aluminum sulfate, sodium acid pyrophosphate, sodium aluminum phosphate, sodium pyrophosphate, humic acid, fulvic acid, and aluminum sulfate.

Compounds which may be added may additionally or alternatively include basic compounds such as potassium hydroxide, sodium hydroxide, calcium hydroxide, other alkali and alkali earth hydroxides, hydroxides of food-safe transitional metals and mineral Lewis acids.

### EXAMPLES

### Example 1. First Test with Organic Acid Oxygen Scavengers

Oxygen dynamics were tested in virgin and additive-containing sippers. The additive formulation was added to a polymer, which may be used to form a product such as a sipper. Here, the sipper's oxygen removing activity was tested both with and without moisture triggering.

In a first test with commercially extruded sippers, samples were produced containing organic acids as catalysts for oxygen scavenging. The additive formulation included 2 parts by weight tartaric acid, 3 parts by weight iron, 0.5 parts by weight clay, and 2.5 parts by weight NaCl. The additive formulation was added to the polymer as a dry mixture. It is to be understood than alternative acids including but not limited to tartaric, maleic, and/or ascorbic acid may alternatively be included in the additive formulation at 15±5 wt % of the additive formulation. Sippers contained 4 wt % of the additive formulation. In this first test, oxygen was removed upon moisture-triggering of additive in the sipper, as designed, but a scorched color and aroma was produced during injection molding. The samples were also very dark.

### Example 2. Second Test with Organic Acid Oxygen Scavengers

In a second test, the additive formulation included 2 parts by weight adipic acid, 3 parts by weight iron, 0.5 parts by weight clay, and 2.5 parts by weight NaCl. The additive formulation was added to the polymer as a dry mixture. It is to be understood that thermostable organic triggering acids including but not limited to fumeric, adipic, and/or polyacetic acid may alternatively be included in the additive formulation at 15±5 wt % of the additive formulation. Sippers contained 4 wt % of the additive formulation. In this second test the additive was compounded into pellets by iCare at their recycling facility in Ohio. Injection molded sippers from this test retained the scorched aroma observed in the first run. Additionally, moisture retention and premature triggering were observed. Presumably, triggering moisture came from cooling water used to solidify extruded pellets. The observed moisture came from a water cooling step inherent to the pelletizing process. Beyond about 7 wt % additive, pellets were moist, ill-formed, and spongy.

### Example 3. Oxygen Dynamics of Additive-Containing Triggered Samples with an Iron Oxygen Scavenger

In a third test, samples were prepared where organic acids were replaced with minerals having Lewis acid functionality. In particular, sippers contained 10% additive formulation by weight. In this example, the additive formulation included 3 parts by weight iron, 3 parts by weight sodium chloride, and 1 part by weight titanium dioxide. The additive formulation was delivered to the polymer by first adding 4 parts by weight (relative to other additive components) mineral oil. Only the external surface of the granule contributed to dark color. Therefore, the color impact on the sipper pieces was minimized with only marginal reduction in theoretical oxygen removing ability. The additive appeared to blend adequately with virgin polymer pellets without a separate pelletizing step. No scorched aroma was observed.

Sippers made from the virgin HDPE had an annual expected net permeation of 5.6 cc O₂ per year. The untriggered additive-containing sipper had an expected permeation of 2.6 cc O₂ per year. The triggered additive-containing sipper removed oxygen and therefore no annual permeation could be ascribed to sipper. Each sipper contained about 50 mg of iron. Iron oxygen scavenger represented approximately ⅓ of the additive by weight. Theoretically, 50 mg of iron will remove about 15 cc O₂. Therefore, theoretically, sippers contain enough oxygen removal capacity to protect food for a year.

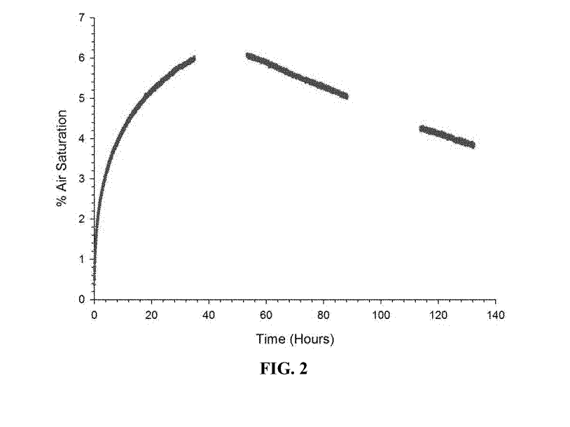

Triggering was initiated by dampening 50 mgs of cotton with water and placing the moistened pellet inside the sipper. Care was taken to assure that the free movement of gas inside the sipper was not impeded. The sipper was mounted on the test rig, purged with nitrogen until 99.9% of the oxygen was removed and then monitored for oxygen dynamics (FIG. 2) over the next 6 days.

There was a characteristic initial increase in oxygen reading related to out-gassing of polymer-entrained oxygen. In general, 24 to 48 hours achieved permeation equilibrium (depending of the presence of tortuosity compounds). FIG. 2 suggests that some additive triggering occurred by about 24 hours. However, oxygen removal did not exceed permeation until the 2nd day of equilibration. The high sampling rate in this (and in the virgin polymer) samples saturated the data buffers of the data acquisition system and data were collected across 3 separate files. Sampling was continuous; however there were 2 regions around 40-55 hours and 80-110 hours where file data were unavailable. It is perhaps worth noting that the oxygen sensor itself consumes some oxygen in course of operation and therefore oxygen removal by the additive can be distinguished from oxygen removal by the oxygen cell. Careful measurements and calculations were made on the oxygen sensor to assess any impact of sensor oxygen removing activity on the trend line of FIG. 2. It was determined that oxygen level would be about 2% higher. For example at 6% air saturation, the oxygen cell-adjusted reading would be 6.012%.

It is contemplated that oxidation triggering may be initiated earlier in the storage cycle. Hot filling pouches with subsequent focused pasteurization of the fitment would reasonably shorten triggering time and accelerate oxygen removal. Also, it is contemplated that the elements could be ground together. Without intending to be bound by theory, such efforts as dispersion and intimate comingling of constituents should favor a higher oxygen removal rate. It is further contemplated that an increased abundance of iron in the formulation might be utilized.

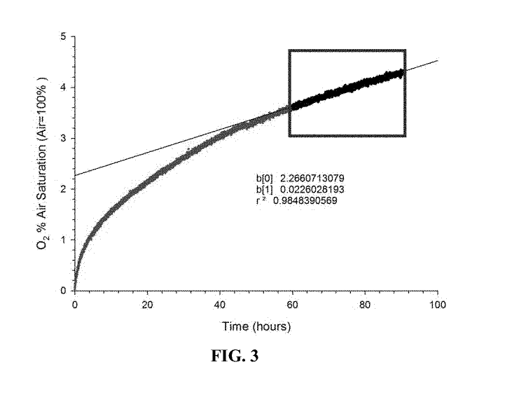

The method for testing the un-triggered additive-containing sample was identical in every respect to the method described above for the triggered sample except the moistened cotton pellet was not placed inside the sipper chamber. Like in FIG. 2, out-gas sing of oxygen from the sipper produced an initial rapid increase in reading followed by steady state region shown in a box (FIG. 3). The slope (b[1]=0.0226% change per hour) of the steady state portion of the line reflects the oxygen permeability of the piece.

Based on the observed data, the untriggered additive-containing sample projected an oxygen permeation through the sipper of 2.62 cc oxygen per year. In addition, there were approximately 0.7 cc oxygen in the sipper at closing. The sum of these two sources would be 3.32 cc of oxygen. This is well within the 15 cc of oxygen removal capacity provided by the additive formulation in the sipper.

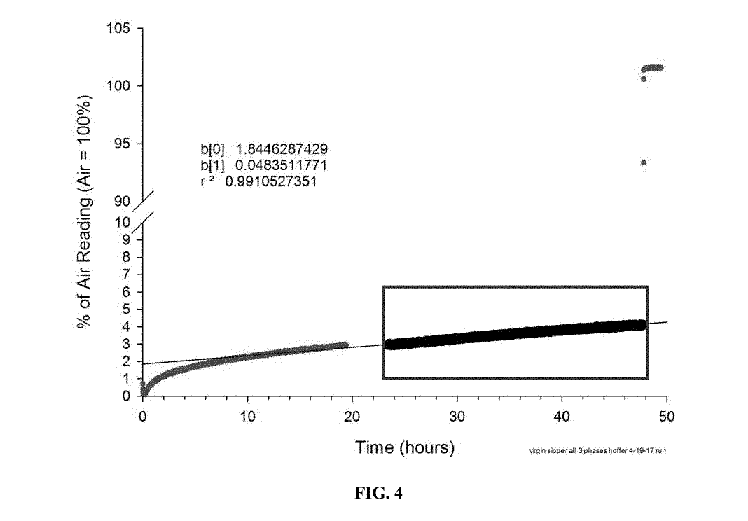

Testing the control sipper made from HDPE without additive employed the same testing procedure described for the un-triggered additive-containing sample. As with FIG. 3, the steady state region is shown in a box with the regression line describing the slope of the steady state region also shown (FIG. 4). Unlike the additive-containing sample (shown in FIG. 3) which achieved steady state after more than 48 hours, the virgin material achieved steady state within about 24 hours. This is consistent with the longer tortuous path for oxygen migration afforded by the additive's tortuosity components. The slope for oxygen permeation through the control sipper was 0.0484% oxygen change per hour. This translates into an annual oxygen permeation of 5.6 cc O₂. Therefore, the oxygen permeability of the un-triggered additive-containing sample was approximately 47% of the permeation through the virgin HDPE sipper.

The 47% reduction is consistent with the first two tests where the tortuosity aid reduced oxygen migration by approximately 50%.

In summary, the un-triggered additive-containing sample had an oxygen permeation of approximately half that of the sipper made from virgin HDPE. This is consistent with the additives of Examples 1 and 2, which similarly indicated a 50% reduction in permeation due to the un-triggered additive alone.

Consistent with the first test with organic acid oxygen scavengers, in the test with an iron oxygen scavenger, oxygen removal did not appear to be triggered until the sipper had access to moisture matching the water activity of the triggering salt.

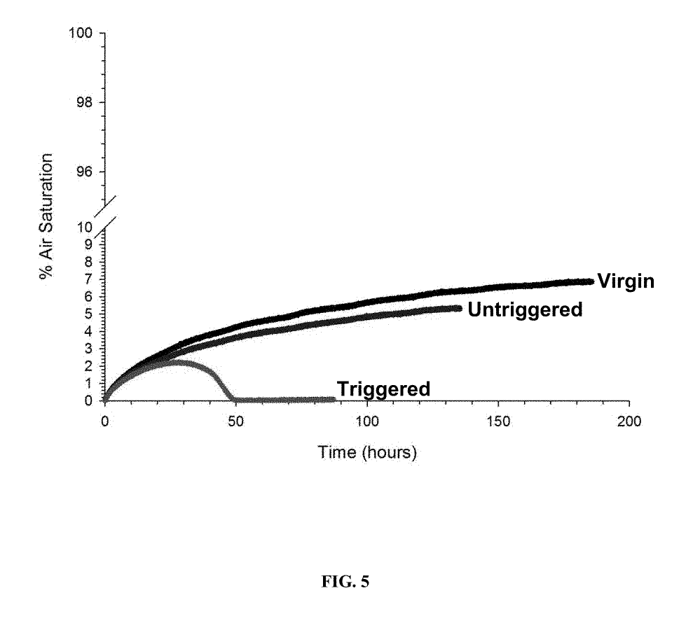

FIG. 5 is a graph of air saturation over time for virgin, untriggered, and triggered sample. There was about 15% decrease in oxygen permeability for the untriggered tortuosity-containing sample.

Without intending to be bound by theory, in the early stages of oxygen removal, the tortuosity-inducting compound in the triggered additive-containing sipper may work against quick triggering. This follows since the mineral structures which inhibit oxygen migration also inhibit the migration of triggering moisture to the iron. It is likely that the higher temperatures experienced by the sipper during food filling and pasteurization will accelerate the triggering rate both by increasing the vapor pressure of the moisture and by increasing the permeability of the olefin medium of the sipper structure. It is contemplated that formulation steps which bring mineral components into greater proximity may facilitate earlier and more vigorous triggering. Additionally, it is contemplated that increasing the clay loading may further reduce the oxygen permeability and lower the cost of the piece (salt and clay are 1/10 and ½ as expensive as the polymer that they replace, respectively).

In the test with an iron oxygen scavenger, there was no scorched aroma or color. It is contemplated that the additive may be added directly to the polyolefin pellets during the extrusion process.

What has been described and illustrated herein is an illustrative embodiment of a composition and method along with some of its variations. The terms, descriptions and figures used herein are set forth by way of illustration only and are not meant as limitations. Those skilled in the art will recognize that many variations are possible within the spirit and scope of disclosure in which all terms are meant in their broadest, reasonable sense unless otherwise indicated. Any headings utilized within the description are for convenience only and have no legal or limiting effect.

1. A plastic packaging material comprising a polymer and an oxygen reactive compound dispersed within the polymer, wherein the polymer comprises tortuous paths therein capable of restricting migration of oxygen through the plastic packaging material.

2. The plastic packaging material of claim 1, wherein the oxygen reactive compound is capable of chemically reacting with oxygen that migrates into the plastic packaging material.

3. The plastic packaging material of claim 1, further comprising a hygroscopic compound dispersed within the polymer.

4. The plastic packaging material of claim 3, wherein the hygroscopic compound induces the tortuous paths in the polymer.

5. The plastic packaging material of claim 3, wherein the oxygen reactive compound remains inactive until moisture fully or partially deliquesces the hygroscopic compound.

6. The plastic packaging material of claim 3, further comprising at least one hydrophilic compound dispersed within the polymer, wherein the hydrophilic compound is capable distributing products of water and the hygroscopic compound.

7. The plastic packaging material of claim 1, wherein the polymer is a polyolefin or ethylene-vinyl acetate.

8. The plastic packaging material of claim 1, wherein the oxygen reactive compound comprises a metal selected from the group consisting of iron, aluminum, chrome, zinc, tin, combinations thereof, and alloys thereof.

9. The plastic packaging material of claim 3, wherein the hygroscopic compound is selected from the group consisting of potassium sulfate, potassium nitrate, potassium chloride, sodium chloride, magnesium nitrate, potassium carbonate, magnesium chloride, and potassium acetate.

10. The plastic packaging material of claim 6, wherein the hydrophilic compound is selected from the group consisting of an acid, a base, an ionic compound, activated carbon, carbon black, and a mineral.

11. The plastic packaging material of claim 6, wherein the hydrophilic compound is selected from the group consisting of cellulose, a modified cellulose, polyethylene glycol, polyacrylic acid, polymethacrylic acid, polyvinyl alcohol, polyvinyl acetate, chitosan, a protein, a dextrin, a starch, polyquaternium, polyacrylamide, another cationic polymer, and another anionic polymer.

12. The plastic packaging material of claim 1, further comprising an organic compound selected from the group consisting of ascorbic acid, cysteine, a bisulfite, a thiosulfate, and combinations thereof.

13. The plastic packaging material of claim 3, wherein the oxygen reactive compound and the hygroscopic compound are uniformly distributed in the polymer.

14. A packaged food product comprising a) food and b) a plastic packaging material enclosing the food, the plastic packaging material comprising a polymer, an oxygen reactive compound dispersed within the polymer, and a hygroscopic compound dispersed within the polymer, wherein the polymer comprises tortuous paths therein capable of restricting migration of oxygen through the plastic packaging material.

15. The packaged food product of claim 14, wherein the oxygen reactive compound remains inactive until moisture fully or partially deliquesces the hygroscopic compound at a triggering relative humidity of the hygroscopic compound.

16. The packaged food product of claim 15, wherein the triggering relative humidity of the hygroscopic compound is less than the equilibrium relative humidity (ERH) of the food.

17. The packaged food product of claim 15, wherein the triggering relative humidity of the hygroscopic compound is greater than the ERH of ambient environment outside of and surrounding the plastic packaging material.

18. The packaged food product of claim 15, wherein the triggering relative humidity of the hygroscopic compound is within 10% of the ERH of the food.

19. A method for forming plastic packaging for food, the method comprising a) mixing an oxygen reactive compound and a hygroscopic compound into a polymer to form the plastic packaging, wherein the hygroscopic compound creates tortuous paths in the polymer and the tortuous paths are capable of restricting migration of oxygen through the plastic packaging and b) enclosing the food in the plastic packaging.

20. The method of claim 19, further comprising selecting the hygroscopic compound based on the ERH of the food such that the resulting humidity surrounding the food after the packaging step reduces damage to the food.
